(19) United States
(12) Patent Application Publication
(10) Pub. No.: US 2026/0167299 A1
(43) Pub. Date: Jun. 18, 2026

(54) Method for Operating a Pedal-Driven Vehicle

(71) Applicant: Robert Bosch GmbH, Stuttgart (DE)

(72) Inventors: Daniel Gronbach, Stuttgart (DE); Joseph Reck, Weil Im Schoenbuch (DE); Juergen Stegmaier, Wannweil (DE); Marcus Boege, Rottenburg Am Neckar (DE); Matthias Weinmann, Balingen (DE)

(21) Appl. No.: 19/412,093

(22) Filed: Dec. 8, 2025

(30) Foreign Application Priority Data
Dec. 16, 2024 (DE) 10 2024 211 963.6

(51) Int. Cl. B62M 25/08; F16H 59/44; F16H 59/68

(52) U.S. Cl. CPC B62M 25/08; F16H 59/44; F16H 59/68; F16H 2716/08

(57) ABSTRACT

A method for operating a pedal-driven vehicle, in particular, a bicycle, a pedal-driven vehicle, a computer program product, a computer-readable medium, and a data carrier signal are disclosed. The pedal-driven vehicle includes a gear shift and a control unit. The method includes (i) determining an actual speed of the pedal-driven vehicle, (ii) determining a shift threshold for the gear shift as a function of the actual speed, (iii) calculating, by way of the control unit, a shift threshold displacement as a function of the actual speed and the shift threshold, and (iv) operating, by way of the control unit, the gear shift as a function of the shift threshold displacement.

This application claims priority under 35 U.S.C. § 119 to patent application no. DE 10 2024 211 963.6, filed on Dec. 16, 2024 in Germany, the disclosure of which is incorporated herein by reference in its entirety.

The disclosure relates to a method for operating a pedal-driven vehicle, a pedal-driven vehicle, a computer program product, a computer-readable medium, and a data carrier signal.

### BACKGROUND

Pedal-driven vehicles, in particular (electric) bicycles (“e-bikes”) or pedelecs, which comprise a control unit and/or an (automatic and/or electric) gear shift are known. The gear shift may be configured to change between different gears. The gear shift may comprise a chain shift, for example with at least one chainring on the crank and a cassette with at least one (mostly several, e.g., 10) chainrings on the rear axle. A cassette may also be referred to as a sprocket pack or pinion pack.

The prior art has disadvantages in this respect. Thus, (automated) gear changes may occur too frequently, particularly with large forces occurring, for example when a gear change occurs at high torque applied by, for example, the rider (rider torque) and/or an (electric) motor (motor torque). This may increase wear. This may cause the chain to jump off. This may result in reduced (riding) comfort. In particular, (too) frequent gear changes may be perceived as annoying. For example, this can result in the pedals sagging and/or (unpleasant) noise. This may (in addition) reduce safety.

### SUMMARY

According to the disclosure, there is provided a method, a pedal-driven vehicle, a computer program product, a computer-readable data medium, as well as a data medium signal with the features set forth below. Further features and details of the disclosure will emerge from the description and the drawings. Features and details described in connection with the method according to the disclosure naturally also apply in connection with the pedal-driven vehicle according to the disclosure and/or in connection with the computer program product according to the disclosure and/or in connection with the computer-readable medium according to the disclosure and/or in connection with the data carrier signal according to the disclosure, and vice versa, so that there is or can always be mutual reference with regard to the disclosure of the individual aspects of the disclosure. In particular, advantages described in the context of the first, second, third, fourth and/or fifth aspects also apply to the first, second, third, fourth and/or fifth aspects, respectively.

According to a first aspect of the disclosure, there is provided a method for operating a pedal-driven vehicle, in particular an (electric) bicycle or pedelec comprising an (electric and/or automatic) gear shift and a control unit, comprising:
determining an actual speed of the pedal-driven vehicle,
(optional) determining an actual gear of the gear shift of the pedal-driven vehicle
determining a shift threshold for the gear shift as a function of the actual speed and/or the actual gear,
calculating, by way of the control unit, a shift threshold displacement as a function of the actual speed and/or the actual gear and the shift threshold,
operating, by way of the control unit, the gear shift as a function of the shift threshold displacement.

The method may be (at least in part) computer-implemented. In particular, operation may comprise control and/or regulation, preferably wherein a control unit (see below) is used, which in particular controls and/or regulates the (automatic and/or electric) gear shift (e.g., by way of actuation signals). The described actions or features of the method can be carried out in the order shown and in particular carried out repeatedly. Preferably, the method may be performed for and/or during operation and/or use of a pedal-driven vehicle and/or a corresponding control unit and/or gear shift. Preferably, the method may be used to operate, in particular control and/or regulate, a pedal-driven vehicle according to the second aspect. A control unit established for this purpose can in particular preferably be used for operation, in particular for control and/or regulation. In so doing, the control unit can perform the corresponding actions or features and/or control (e.g., via actuation signals) to preferably implement the actions. For example, actuators (e.g., the gear shift) connected to the controller for data communication via a data link may be controlled by the control unit (as part of the operation). By this, for example, an automatic gear change may be realized. The gear shift may also transmit to the controller an actual (measured) gear.

The method may be configured to provide an (upper and/or lower) shift threshold for each gear of the gear shift, in particular. In other words, hysteresis or corresponding hysteretic behavior can be provided, in particular for each gear (wherein the lowest gear can only have an upper shift threshold and/or the highest gear can only have a lower shift threshold). This may reduce the number of gear changes. This may optimize safety, comfort, and/or wear.

A determination of an actual speed of the pedal-driven vehicle may be performed. This may be known to the control unit in the simplest case. A measurement of the actual speed can be performed. For example, the actual speed can be determined via a sensor, e.g. a reed sensor and/or an (induction) coil having a permanent magnet on the wheel are measured and/or subsequently transmitted to the control unit. Alternatively or additionally, the speed may be determined via a GPS signal. The actual speed can be determined (continuously) over time. Depending on the actual speed, a time course, e.g. a first temporal derivation (acceleration) is also determined.

The shift threshold may comprise an upper shift threshold, which is in particular above/higher than the actual speed (in particular at the gear change time).

The shift threshold may comprise a lower shift threshold, which is in particular configured below/less than the actual speed (in particular at the gear change time).

A shift threshold for the gear shift may be determined as a function of the actual speed, wherein an (upper and/or lower) shift threshold may be provided for an/each actual speed and/or a (each) gear of the gear shift. In so doing, an/each (upper and/or lower) shift threshold may be predefined and/or stored in the control unit. For example, they may be stored in a (lookup) table. As a result, an (upper and/or lower) shift threshold may be provided as a function of an actual speed and/or an actual gear (in each case). The (upper and/or lower) shift threshold, in particular with and/or in combination with the (upper and/or lower) shift threshold displacement, may accordingly have a speed and/or an (upper and/or lower) limit (or a limit value) from which (or upon reaching which) a shifting operation (up into a [next] higher gear and/or downward into a [next] lowest gear) is initiated.

For example, travel in a tenth gear may be provided. For example, an actual speed may be 20 km/h. For example, the upper shift threshold may be 22 km/h. Thus, for example, if the actual speed of 22 km/h is reached or exceeded, operation, in particular an upshift, can be achieved. For example, the lower shift threshold may be 18 km/h. Accordingly, operation, in particular a downshift, can be achieved upon reaching or falling below the actual speed of 18 km/h.

The shift threshold displacement may have a lower shift threshold displacement, which is particularly specific for the lower shift threshold.

The shift threshold displacement may have an upper shift threshold displacement, which is particularly specific for the upper shift threshold.

Calculating, by way of the control unit, a shift threshold displacement as a function of the actual speed and the shift threshold can in the simplest case comprise a retrieval, in particular by and/or from the control unit. For example, it may be contemplated that the (upper and/or lower) shift threshold for an actual speed and/or an actual gear be retrieved from a lookup table. Alternatively or additionally, it may be provided that an (upper and/or lower) shift threshold is calculated as a function of the actual speed and/or the actual gear, for example by retrieving a pre-saved (upper and/or lower) shift threshold and then, as a function of a time curve of the actual speed (e.g., via the first time derivative, in particular an acceleration), the (upper and/or lower) shift threshold is increased or decreased by an (upper and/or lower) shift threshold displacement. For example, in a fast acceleration operation, the (upper and/or lower) shift threshold and/or (upper and/or lower) shift threshold displacement may be set higher or lower (e.g., as a percentage). This may increase the shift comfort. In particular, this enables faster shifting. It can also be provided that the (upper and/or lower) shift threshold and/or (upper and/or lower) shift threshold displacement is determined as a function of the actual speed, for example, wherein the actual speed, e.g. is used directly after a gear shift, and the (upper and/or lower) shift threshold is set above and/or below the actual speed by an interval, for example +/−2 km/h or +/−10% of the actual speed. In this case, the (upper and/or lower) shift threshold displacement may (also) be, for example, +/−2 km/h or +/−10% of the actual speed or the (upper and/or lower) shift threshold, wherein, in particular, an upper shift threshold displacement is above (or below) an upper shift threshold and/or a lower shift threshold displacement is below (or above) a lower shift threshold.

The (upper and/or lower) shift threshold displacement may have an offset by which the (upper and/or lower) shift threshold is shifted and/or modified.

For example, travel in a tenth gear may be provided. For example, an actual speed may be 20 km/h. For example, the upper shift threshold may be 22 km/h. Thus, for example, if the actual speed of 22 km/h is reached or exceeded, operation, in particular an upshift, can be achieved. For example, the lower shift threshold may be 18 km/h. Accordingly, operation, in particular a downshift, can be achieved upon reaching or falling below the actual speed of 18 km/h.

For example, an upper shift threshold displacement may be +1 km/h, which (at least temporarily) would result in an upshift (only) occurring upon reaching or exceeding 23 km/h. This may reduce the frequency of gear changes and/or may increase ride comfort.

For example, a lower shift threshold displacement may be −1 km/h, which (at least temporarily) would result in a downshift (only) occurring when reaching or falling below 17 km/h. This may reduce the frequency of gear changes and/or may increase ride comfort.

For example, the operation of the pedal-driven vehicle by the control unit as a function of the shift threshold displacement may comprise control and/or regulation by the control unit, preferably of gear shift and/or a functionally essential component of the pedal-driven vehicle, such as a driver assistance system (e.g., ABS) and/or a (electric) engine. In so doing, they can be operated via corresponding control signals (to actuators).

In the context of the disclosure, it may be advantageous for the determination and/or calculation to be performed as a function of an actual gear of the gear shift and/or a target pedaling frequency of a rider and/or an actual pedaling frequency (e.g., measured at the crank and/or by a torque sensor).

The (previous and/or current and/or next) actual gear (or target gear) may be known to and/or measured by the control unit (in particular with automatic shifting), for example by a corresponding sensor, e.g. on a cassette of the gear shift.

It may be provided that, in particular until the completion of a (following) gear change, the method is performed (once) at and/or for and/or after a gear change and/or at the gear change time and/or for an actual gear. Accordingly, the (upper and/or lower) shift threshold and/or the (upper and/or lower) shift threshold displacement may be determined and/or calculated (once). The gear change time may be the time at which the gear change is initiated or the time at which the gear change is completed.

The determination of the (upper and/or lower) shift threshold can occur as a function of the actual gear and/or the actual speed. For example, an (upper and/or lower) shift threshold may be stored in the control unit for (each) (actual) gear and/or (each) (actual) speed (or for discrete speed ranges) of the pedal-driven vehicle. Alternatively, this may be varied and/or calculated (see also above).

Calculating the (upper and/or lower) shift threshold displacement can be performed as a function of the actual gear and/or the actual speed. For example, an (upper and/or lower) shift threshold displacement may be stored in the control unit for (each) (actual) gear and/or (each) (actual) speed (or for discrete speed ranges) of the pedal-driven vehicle. Alternatively, this may be varied and/or calculated (see also above).

The target pedaling frequency (or desired/comfortable pedaling frequency) may be input by the rider, for example via an input device of the control unit. For example, a target speed can be determined for a specific target pedaling frequency for each (actual) gear, at which the target pedaling frequency is preferably achieved in the corresponding (actual) gear. If the actual speed deviates (too) significantly upwards or downwards (and correspondingly also the current/actual pedaling frequency), a gear change may be initiated. This may be achieved as a function of the (upper and/or lower) shift threshold and/or (upper and/or lower) shift threshold displacement.

Accordingly, a gear change and/or the (upper and/or lower) shift threshold may be determined as a function of the target pedaling frequency and/or actual pedaling frequency. In this case, in particular in the control unit, a gear ratio and/or a tire circumference may be stored for a (each) actual gear. As a result, the gear selection may be made in such a way that it is substantially always possible to pedal at the target pedaling frequency (at the crank and/or by the rider) or within a range may around the target pedaling frequency.

It is also contemplated that an (upper and/or lower) shift threshold displacement (in the control unit) may be stored and/or changeable for (each) gear. This allows a rider to specifically adjust the shift frequency for optimal ride comfort.

In the context of the disclosure, it is conceivable that the detection and/or calculation is performed as a function of a gear change of the gear shift, in particular at a gear change time, wherein in particular the detection and/or calculation for an actual gear is performed after a detection, in particular the (successful and/or completed) performance, of a gear change.

Accordingly, the actual gear, the (upper and/or lower) shift threshold, the actual pedaling frequency, and/or the (upper and/or lower) shift threshold displacement may be determined and/or calculated for and/or from a (recently completed) gear change.

The gear change time may be used as the (temporal) reference point. The process can be performed again and/or repeated for and/or during and/or after each gear change (i.e., for the current actual gear and/or the current actual speed). This may advantageously allow for optimal adjustment and/or optimize ride comfort.

It may be provided in the context of the disclosure that the shift threshold comprises:
an upper shift threshold specific for a (further and/or subsequent) gear change to a (next) higher gear and/or for speeds above the actual speed (particularly at the gear change time),
a lower shift threshold specific for a (further and/or subsequent) gear change to a (next) lower gear and/or for speeds below the actual speed (particularly at the gear change time),
and/or
the shift threshold displacement comprises:
   an upper shift threshold displacement specific to a further gear change to a (next) higher gear and/or the upper shift threshold, and in particular added to (or subtracted from) the upper shift threshold, (see below),
   a lower shift threshold displacement specific to a further gear change to a (next) lower gear and/or the lower shift threshold, and in particular subtracted from (or added to this) the lower shift threshold, (see below),

Accordingly, it may be provided that if the upper shift threshold, in particular including (preferably added or subtracted) the upper shift threshold displacement, is reached or exceeded, a further gear change, in particular into a (next) higher gear, is performed.

Accordingly, it may be provided that if the lower shift threshold, in particular including (preferably subtracted or added) the lower shift threshold displacement is reached or fallen below, a further gear change, in particular into a (next) lower gear, is performed.

It is further contemplated that the shift threshold displacement is configured to temporarily vary the shift threshold for a displacement time.

Accordingly, the displacement period may have an upper and/or lower displacement time period for the upper and/or lower shift threshold and/or shift threshold displacement. The upper and lower displacement time period may be different.

For example, the (upper and/or lower) displacement time period may have a (fixed) time interval, for example 2 seconds, and/or a (fixed) number of revolutions of the cassette of the gear shift (e.g., 3 revolutions). It may also be provided that the (upper and/or lower) displacement time period may be variably configured. This may be selected, for example, for as long as the gear shift is transmitted to the control unit and the gear shift is (fully) completed. This may prevent (too) frequent gear changes. This may increase comfort. This may also prevent a (further) gear change from being initiated before the previous one is (fully) completed. This may optimize wear and/or safety.

It is also contemplated that the shift threshold displacement is configured to temporarily increase or reduce the shift threshold for the displacement time period, wherein in particular
the upper shift threshold displacement temporarily increases (or decreases) the upper shift threshold for an upper displacement time period, wherein in particular, the upper shift threshold displacement is set to zero (in terms of time) thereafter,
a lower shift threshold displacement temporarily decreases (or increases) the lower shift threshold for a lower displacement time period, wherein in particular, the lower shift threshold displacement is set to zero thereafter.

In the context of the disclosure, it is optionally possible that the displacement time period, in particular starting with a gear change time, keeps the shift threshold displacement
constant for a first (upper and/or lower) time period, and/or
decreases or increases for a second (upper and/or lower) time period, in particular linearly and/or in terms of amount.

The first and/or second upper and/or lower time period may be specific to the upper and/or lower shift threshold and/or shift threshold displacement.

Accordingly, the upper and/or lower shift threshold displacement may be constant (initially) for a first (upper and/or lower) time period, e.g. for 2 seconds.

In doing so, in particular subsequently, the upper and/or lower shift threshold displacement may decrease (or increase) and/or increase (or decrease) linearly, in particular over the second (upper and/or lower) time period, in particular until the (original and/or actual) (upper and/or lower) shift threshold is reached and/or the (contribution of the) (upper and/or lower) shift threshold displacement is zero. For example, the second (upper and/or lower) time period may be 2 seconds.

Furthermore, it may be provided within the scope of the disclosure that the calculation of a shift threshold displacement is performed as a function of the actual speed and the shift threshold, additionally as a function of a shift direction and/or a fast shift-through (up or down) and/or a shift speed and/or shift/gear change frequency, in particular in the case of one (or more) gear change(s).

In other words, the hysteresis may depend on the shift direction (gear change) down or up and/or the shift speed and/or shift frequency.

Depending on the shift direction and/or a fast shift (up [to higher gears] and/or down [to lower gears]), and/or a shift speed and/or shift/gear change frequency and/or acceleration (or deceleration), the (upper and/or lower) shift threshold, the (upper and/or lower) shift threshold displacement, the (upper and/or lower) first time period, and/or the (upper and/or lower) second time period can be calculated and/or determined.

For example, rapid shift-through at a high acceleration (of the pedal-driven vehicle) may be desired.

It may be provided that, depending on the actual speed (by calculating a first derivation of the speed) and/or by an accelerometer (connected to the control unit), an acceleration (or deceleration) is determined.

Here, for example, when a limit value is reached or exceeded by (the amount of) the acceleration, in particular in connection with multiple consecutive gear changes in the same direction (up or down), a (quick) shift can be achieved and/or (the desire) can be detected.

It may be provided that a particularly repeated and/or multiple and/or fast shift in a shift direction (i.e. upshift or downshift) is detected by the control unit. For example, in the event of repeated and/or multiple shifts within an (upper and/or lower) switching direction interval, e.g. 2 or 5 seconds, the control unit can perform a calculation depending on the shift direction and/or a quick switch-through.

With respect to the present disclosure, it is conceivable that
in the case of a quick shift-through (upwards) and/or upshifting, the shift threshold displacement, in particular the upper shift threshold displacement, causes a reduction in the shift threshold, in particular the upper shift threshold, and/or has a negative upper shift threshold displacement (e.g., −2 km/h), and/or
in the case of a quick shift-through (downwards) and/or downshifting, the shift threshold displacement, in particular the lower shift threshold displacement, causes an increase in the shift threshold, in particular the lower shift threshold, and/or has a positive upper shift threshold displacement (e.g., +2 km/h).

This may advantageously enable a faster shift-through (up and/or down). This may optimize ride comfort and/or acceleration and/or deceleration behavior.

Furthermore, it is conceivable that the operation, by way of the control unit, of the pedal-driven vehicle is performed as a function of the shift threshold displacement and the shift threshold.

In the context of the disclosure, it may be advantageous for a (further) gear change to be performed
to a (next) higher gear when the actual speed reaches or exceeds an upper shift threshold to which an upper shift threshold displacement is added (or subtracted from),
to a (next) lower gear when the actual speed reaches or drops below a lower shift threshold from which a lower shift threshold displacement is subtracted (or added).

According to a second aspect, there is provided a pedal-driven vehicle according to the present disclosure comprising at least one control unit and/or a (chain) gear shift, wherein the pedal-driven vehicle is configured to operate according to a (by a) method according to the first aspect.

The pedal-driven vehicle and/or the (electrical and/or automatic) gear shift may be operated by a control unit (of the pedal-driven vehicle). The control unit may comprise a memory and/or a computing unit, in particular a computer and/or device for processing data. The control unit can be connected to the gear shift for data communication and, in particular, operate it (control and/or regulate it) by way of control signals, for example by way of corresponding actuators of the gear shift, e.g. on a rear derailleur of the gear shift. It may also be provided that the control unit comprises an input device via which data can be input. For example, the rider may define and/or modify the (upper and/or lower) shift threshold and/or the (upper and/or lower) shift threshold displacement.

Thus, with respect to a pedal-driven vehicle according to the disclosure according to the second aspect, the same advantages as those already described with respect to a method according to the disclosure according to the first aspect arise.

According to a third aspect, there is provided a computer program product according to the present disclosure comprising instructions that cause a pedal-driven vehicle according to the second aspect to perform a method according to the first aspect.

Thus, with respect to a computer program product according to the disclosure according to the third aspect, the same advantages result as have already been described with respect to a method according to the disclosure according to the first aspect and/or a pedal-driven vehicle according to the second aspect according to the disclosure.

According to a fourth aspect, there is provided a computer-readable data carrier according to the present disclosure having stored thereon a computer program product according to the third aspect.

Thus, with respect to a computer-readable medium according to the fourth aspect, the same advantages arise as have already been described with respect to a method according to the first aspect and/or a pedal-driven vehicle according to the second aspect and/or a computer program product according to the third aspect according to the disclosure.

According to a fifth aspect, a data carrier according to the disclosure is provided that transmits a computer program product according to the fourth aspect.

Thus, with respect to a data carrier signal according to the fifth aspect, the same advantages result as have already been described in relation to a method according to the first aspect and/or a pedal-driven vehicle according to the second aspect and/or a computer program product according to the third aspect and/or a computer-readable data carrier according to the fourth aspect.

### BRIEF DESCRIPTION OF THE DRAWINGS

Further advantages, features, and details of the disclosure emerge from the following description, in which several exemplary embodiments of the disclosure are described in detail with reference to the drawings. The features mentioned in the claims and in the description can each be essential to the disclosure individually or in any combination. Exemplary schematics show:

FIG. 1 a method,

FIG. 2 a pedal-driven vehicle; and

FIG. 3 a time course of a speed.

In the figures, identical reference signs are used for the same technical features even of different exemplary embodiments.

### DETAILED DESCRIPTION

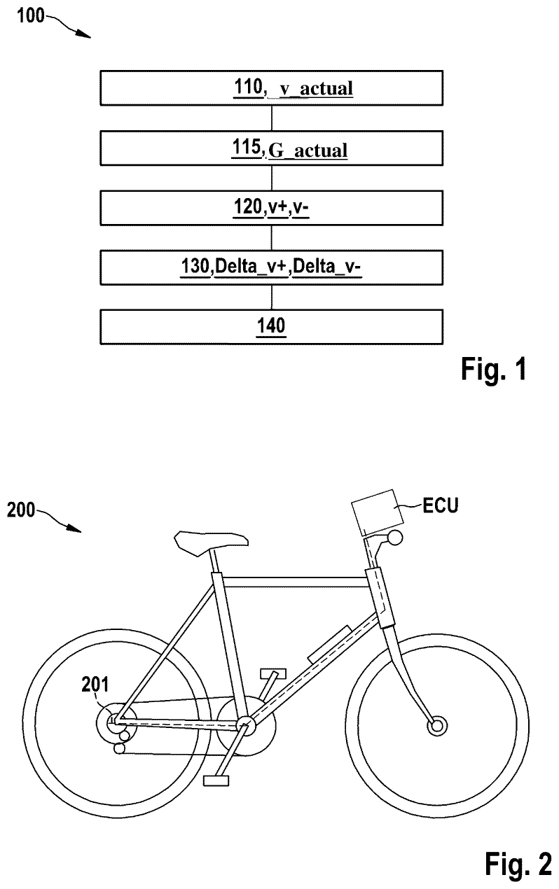

FIG. 1 illustrates, by way of example, a method 100 for operating 140 a pedal-driven vehicle 200, in particular a bicycle, comprising a gear shift 201 and a control unit ECU, the method 100 comprising:
determining 110 an actual speed v_actual of the pedal-driven vehicle 200,
determining 120 a shift threshold v+, v− for the gear shift 201 as a function of the actual speed v_actual and/or the actual gear G_actual,
calculating 130, by way of the control unit ECU, a shift threshold displacement Delta_v+, Delta_v− as a function of the actual speed v_actual and the shift threshold v+, v−,
operating 140, by way of the control unit ECU, the pedal-driven vehicle 200 as a function of the shift threshold displacement Delta_v+, Delta_v−.

In the context of the disclosure, it may be advantageous that determining 120 and/or calculating 130 is performed as a function of an actual gear G_actual of the gear shift 201.

In the context of the disclosure, it is contemplated that determining 120 and/or calculating 130 will be performed as a function of a gear change of the gear shift 201, in particular at a gear change time t0, in particular determining 120 and/or calculating 130 for an actual shift G_actual is performed after a determination 115, in particular of a gear change.

It may be provided in the context of the disclosure that the shift threshold v+, v− comprises:
an upper shift threshold v+ specific for a further gear change to a higher gear,
a lower shift threshold v− specific for a further gear change to a lower gear,
And
that the shift threshold displacement Delta_v+, Delta_v− comprises:
an upper shift threshold displacement Delta_v+ specific for a further gear change to a higher gear, and in particular added to the upper shift threshold v+,
a lower shift threshold displacement Delta_v− specific for a further gear change to a lower gear, and in particular subtracted from the lower shift threshold v−.

It is further contemplated that the shift threshold displacement Delta_v+, Delta_v− is configured to vary the shift threshold v+, v− temporarily for a displacement time period Delta_t+, Delta_t−.

It is also contemplated that the shift threshold displacement Delta_v+, Delta_v− is configured to increase or reduce the shift threshold v+, v− temporarily for the displacement time period Delta_t+, Delta_t− , wherein in particular
the upper shift threshold displacement Delta_v+ temporarily increases the upper shift threshold v+ for an upper displacement time period Delta_t+, wherein in particular the upper shift threshold displacement Delta_v+ to zero is set to zero thereafter,
a lower shift threshold displacement Delta_v− temporarily reduces the lower shift threshold for a lower displacement time period Delta_t−, wherein in particular the lower shift threshold displacement Delta_v− is set to zero thereafter.

In the context of the disclosure, it is optionally possible that the displacement time period Delta_t+, Delta_t−, in particular starting with a shift time t0,
keeps the switching threshold shift Delta_v+, Delta_v− constant for a first time period Delta_t01, and/or
decreases or increases it for a second time period, Delta_t12, in particular linearly and/or in terms of amount.

Further, it may be provided in the context of the disclosure that calculating (130) a shift threshold displacement Delta_v+, Delta_v− is performed as a function of the actual speed v_actual and the shift threshold v+, v−, additionally as a function of a shift direction, in particular during a gear change.

With respect to the present disclosure, it is conceivable that
during an upshift, the shift threshold displacement Delta_v+, Delta_v−, in particular the upper shift threshold displacement Delta_v+, results in a reduction of the shift threshold v+, v−, in particular the upper shift threshold v+, and/or
during a downshift, the shift threshold displacement Delta_v+, Delta_v−, in particular the lower shift threshold displacement Delta_v−, results in an increase in the shift threshold v+, v−, in particular the lower shift threshold v−.

Further, it is contemplated that operation 140 by way of the control unit ECU, of the pedal-driven vehicle 200 is performed as a function of the shift threshold displacement Delta_v+, Delta_v− and the shift threshold v+, v−.

In the context of the disclosure, it may be advantageous for a further gear change to be performed
into a higher gear when the actual speed v_actual reaches or exceeds an upper shift threshold v+ to which an upper shift threshold displacement Delta_v+ is added,
into a lower gear when the actual speed (v_actual) reaches or falls below a lower shift threshold v−, from which a lower shift threshold displacement Delta_v− is subtracted.

FIG. 2 illustrates, by way of example, a pedal-driven vehicle 200 comprising at least one control unit ECU and a gear shift 201, wherein the pedal-driven vehicle 200 is configured to be operated according to a method 100 (cf. FIG. 1 and/or according to the first aspect). The control unit ECU may be connected for data communication to the gear shift 201 via a data link (dashed). By this, the control unit ECU may drive and/or control the pedal-driven vehicle 200 and/or the gear shift 201 as part of the operation 140.

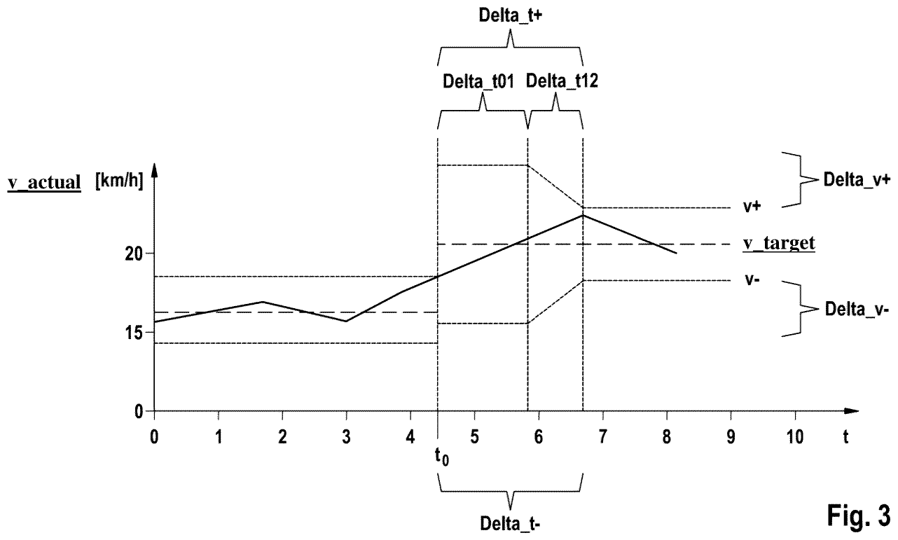

FIG. 3 exemplifies an actual speed v_actual, in particular over a time period (here 10 seconds). A first (low) gear is engaged in a first portion on the left (about from 0 to t0). A second (higher) gear is engaged in a second section on the right (about from t 0 to 10 seconds). A gear change may take place, be initiated, and/or be completed at gear change time t0. The target speed v_target can exemplarily represent an optimal speed at which (in the corresponding gear) a target pedaling frequency is enabled for the rider. If the actual speed v_actual (in a corresponding gear) is too far from the target speed v_target, a gear change may be advantageous to (again) be closer to the target pedaling frequency. For example, a gear shift may be initiated when (as at the end of the first/left portion) the actual speed v_actual reaches or exceeds an (upper) shift threshold v+. In this process, a (new) upper shift threshold v+and/or lower shift threshold v-can be determined during and/or for and/or after the gear change and/or gear change time t0.

In this respect, an upper shift threshold displacement Delta_v+ may be calculated, which is in particular intended to be/is provided over/for an upper displacement time period Delta_t+, and in particular the upper shift threshold v+ shifts and/or is added to it (or, in particular in the case of a quick shift-through and/or downshift, subtracted from it).

In this respect, a lower shift threshold displacement Delta_v− may be calculated, which is in particular intended to be/is provided over/for a lower displacement time period Delta_t−, and in particular the lower shift threshold v− shifts and/or is subtracted from it (or, in particular in the case of a quick shift-through and/or upshift, added to it).

A first time period Delta_t01 can be provided, over which a constant curve of the upper shift threshold displacement Delta_v+ and/or lower shift threshold displacement Delta_v− can be provided.

A second time period Delta_t12 can be provided, via which a linearly decreasing and/or increasing curve of the upper shift threshold displacement Delta_v+ and/or lower shift threshold displacement Delta_v− can be provided, where in particular an adjustment to the upper shift threshold v+ and/or lower shift threshold v-can be achieved.

What is claimed is:

1. A method for operating a pedal-driven vehicle that includes a gear shift and a control unit, the method comprising:
determining an actual speed of the pedal-driven vehicle;
determining a shift threshold for the gear shift as a function of the actual speed;
calculating, by way of the control unit, a shift threshold displacement as a function of the actual speed and the shift threshold; and
operating, by way of the control unit, the gear shift as a function of the shift threshold displacement.

2. The method according to claim 1, wherein the shift threshold determining step and/or the calculating step is performed as a function of an actual gear of the gear shift and/or a target pedaling frequency of a rider.

3. The method according to claim 1, wherein:
the shift threshold determining step and/or the calculating step is performed as a function of a gear change of the gear shift at a gear change time, and
the shift threshold determining step and/or the calculating step for an actual gear is performed after performing a gear change.

4. The method according to claim 1, wherein:
the shift threshold comprises:
an upper shift threshold specific for a further gear change to a higher gear, and
a lower shift threshold specific for a further gear change to a lower gear; and
the shift threshold displacement comprises:
an upper shift threshold displacement specific for a further gear change to a higher gear, and added to the upper shift threshold, and
a lower shift threshold displacement specific for a further gear change to a lower gear, and subtracted from the lower shift threshold.

5. The method according to claim 1, wherein the shift threshold displacement is configured to vary the shift threshold temporarily for a displacement time period.

6. The method according to claim 5, wherein the shift threshold displacement is configured to increase or reduce the shift threshold temporarily for the displacement time period.

7. The method according to claim 5, wherein the displacement time period starting with a gear change time keeps the shift threshold displacement:
constant for a time period, and/or
decreases or increases it for a second time period linearly and/or in terms of amount.

8. The method according to claim 1, wherein the calculating step is performed as a function of the actual speed and the shift threshold, and additionally as a function of a shift direction during a gear change.

9. The method according to the claim 8, wherein:
during an upshift, the upper shift threshold displacement results in a reduction of the upper shift threshold, and/or
during a downshift, the lower shift threshold displacement results in an increase in the lower shift threshold.

10. The method according to claim 1, wherein the operating step is performed as a function of the shift threshold displacement and the shift threshold.

11. The method according to claim 6, wherein another gear change is performed:
to a higher gear when the actual speed reaches or exceeds an upper shift threshold, to which an upper shift threshold displacement is added, and
to a lower gear when the actual speed reaches or falls below a lower shift threshold, from which a lower shift threshold displacement is subtracted.

12. A pedal-driven vehicle comprising at least one control unit, wherein the pedal-driven vehicle is configured to be operated according to the method of claim 1.

13. A computer program product comprising instructions that cause the pedal-driven vehicle to perform the method according to claim 1.

14. A computer-readable data carrier, on which the computer program according to claim 13 is stored.

15. A data carrier signal transmitting the computer program product according to claim 13.

16. The method according to claim 1, wherein the pedal-driven vehicle is a bicycle.

17. The method according to claim 6, wherein:
the upper shift threshold displacement temporarily increases the upper shift threshold for an upper displacement time period, and the upper shift threshold displacement is set to zero thereafter, and
a lower shift displacement temporarily reduces the lower shift threshold for a lower displacement time period, and the lower shift threshold displacement is set to zero thereafter.
